(19) United States
(12) Patent Application Publication
(10) Pub. No.: US 2025/0076091 A1
(43) Pub. Date: Mar. 6, 2025

(54) DEVICES AND SYSTEMS FOR WATER FLOW MONITORING

(71) Applicant: DRIZZLEX, LTD., Jerusalem (IL)

(72) Inventor: Ariel Altura, Jerusalem (IL)

(21) Appl. No.: 18/823,036

(22) Filed: Sep. 3, 2024

Related U.S. Application Data
(60) Provisional application No. 63/536,101, filed on Sep. 1, 2023.

(51) Int. Cl. G01F 1/075; G01D 4/00; G01D 4/02

(52) U.S. Cl. CPC G01F 1/0755; G01D 4/004; G01D 4/02

(57) ABSTRACT

The invention provides a uniquely designed flowmeter device to be coupled to a plumbing fixture (i.e., a faucet, showerhead, toilet, etc.) and provide improved and automated monitoring of water flow characteristics through such plumbing fixture. The flowmeter device allows for monitoring of overall water usage, wherein such water usage information is useful in determining and associating appropriate billing of water usage to a corresponding user, as well as identifying abnormal water usage indicative of potential leaks or damage to the plumbing fixture or supply line(s).

### CROSS-REFERENCE TO RELATED APPLICATIONS

This application claims priority to, and the benefit of, U.S. Provisional Application No. 63/536,101, filed on Sep. 1, 2023, the content of which is incorporated by reference herein in its entirety.

### TECHNICAL FIELD

The disclosure relates generally to water usage monitoring and management. More specifically, the present invention includes a uniquely designed flowmeter device configured to be coupled to a plumbing fixture (i.e., a faucet, showerhead, toilet, etc.) and provide improved and automated monitoring of water flow characteristics through such plumbing fixture, allowing for monitoring of overall water usage, wherein such water usage information is useful in determining and associating appropriate billing of water usage to a corresponding user, as well as identifying abnormal water usage indicative of potential leaks or damage to the plumbing fixture or supply line(s).

### BACKGROUND

The monitoring of water flow in facilities having a large number of water outlets (i.e., apartments, condominiums, office buildings, etc.) is of environmental and economic importance. Many apartment buildings and condominiums are constructed with no central outlet for each apartment, which essentially prevents metering the water flow used by each individual housing unit. Typically, a single central water flow meter is installed within a mainline that distributes water to a building, and water usage is billed to the condominium or apartment owner or managing company, based on the overall usage of water consumed by all households, as measured by the central meter. Consequently, the overall cost of water is shared equally or allocated based on a pro-rata share of the total living area, regardless of the actual quantity of water consumed in each housing unit. In such arrangements, individual tenants do not pay the actual price of excessive, wasteful, or inefficient water usage habits, nor is there an economic reward to individual tenants who implement water-saving practices. The same applies to the subject of inhouse leaking water outlets, which are often overlooked due to wasteful water consumption habits, tended to develop.

As such, the water crisis and the resultant water expenses is driving property owners and managing societies to employ any possible water conservation means. When possible, water meters are installed in each unit and provide a means for billing tenants directly for the water consumed in their unit. The installation of water meters has a dramatic effect on lowering water flow rates, and even when they do not, still it is allowing a fair billing of actual such usage.

However, the downside of the installation of per unit water flow meters is that it has generally been practical only in buildings having a main distribution outlet for each housing or commercial unit being metered. Many buildings and commercial centers are not plumbed in this manner. Rather, water in these facilities is supplied to each unit from multiple water risers serving a number of distribution outlets (e.g., one at each floor, etc.). As a result, there are consistent attempts to provide a metered monitoring system comprising the installation of multiple water meters (i.e., one for each water outlet of any individual housing unit).

For example, U.S. Pat. No. 5,986,573 discloses a method and apparatus for metering building structures having a plurality of service outlets each having control valves, which includes the installation of meters within a given distance from each one of the valves. A transmission system is coupled electrically to each one of the meters for sending meter readings periodically to a remotely located equipment. U.S. Pat. No. 5,892,158 discloses a method for installing a flow meter system and flow meter apparatus, in which the flow meter system has a meter assembly and a transmitter device in conjunction with a utility distribution system disposed behind a wall in a space and having a conduit extending through a conduit opening in the wall for coupling a fixture thereto. The meter assembly is connected in fluid communication with the conduit and positioned outside of the space and in front of the wall. The transmitter device is installed within the space and positioned remotely from the meter assembly. The transmitter device is connected electrically to the transmitter device, and the fixture is coupled in fluid communication with the meter assembly, thereby concealing the meter assembly and the conduit opening. Another type of proposed water monitoring system (as disclosed in Chinese Patent No. CN107402051) discloses a flow recorder with a wireless monitoring function. The flow recorder comprises a signal collection and control circuit, a 3DR data transmission module, a PC computer, and client-side software.

Such prior attempts to solve water usage monitoring previously described herein have numerous drawbacks. For example, such technologies may generally require certain wired communication setups that are difficult to install or may rely on power consuming and range-limited wireless communications, such as Bluetooth®, Wi-Fi, and the like, which can lead to many faults in the system. One potential drawback is the need to install a sensing module and a transmitting module in different locations (i.e., in front and behind a wall), as well as rather large and awkwardly-shaped structure of each meter. Such drawbacks are emphasized by the need for a power supply and by the tendency of occupants of a given property (i.e., residential and/or commercial buildings, including large, multi-unit housing or commercial complexes) failing to report and/or maintain faults in the meters, such as dead batteries, or other errors or dysfunction. In some cases, occupants may be motivated to tamper with the meters in order to avoid water flow charges for water usage. Another drawback of water usage monitoring devices is a poor structural design, in that current flowmeter devices are prone to poor accuracy and breaking down due to wear and tear as a result of debris accumulating within internal components thereof.

### SUMMARY

The invention of the present disclosure addresses the drawbacks of current water monitoring systems and devices. In particular, the present invention provides a uniquely designed flowmeter device to be coupled to a plumbing fixture (i.e., a faucet, showerhead, toilet, etc.) and provide improved and automated monitoring of water flow characteristics through such plumbing fixture. The flowmeter device allows for monitoring of overall water usage, wherein such water usage information is useful in determining and associating appropriate billing of water usage to a corresponding user, as well as identifying abnormal water usage indicative of potential leaks or damage to the plumbing fixture or supply line(s).

More specifically, in one aspect, the uniquely designed flowmeter of the present invention includes, among other things, 1) a main flow channel defining a fluid pathway and comprising an upstream inlet and a downstream outlet, the main flow channel configured to receive water flowing from a water supply line and provide said water to a plumbing fixture, 2) a rotatable member positioned within the main flow channel between the inlet and outlet and configured to rotate in response to water flowing through the main flow channel, the rotatable member being mounted to an axle member, and 3) a multi-pole magnet mounted to an upper end of the axle member and isolated from the main flow channel via a bearing plate positioned about the axle member and enclosing the multi-pole magnet and upper end of the axle member within a chamber separated from the main flow channel, the multi-pole magnet configured to correspondingly rotate upon rotation of the rotatable member. The flowmeter device further includes a sensing module configured to sense an amount of water flow through the main flow channel based, at least in part, on rotation of the rotatable member and corresponding rotation of the multi-pole magnet, and a communication module configured to transmit, receive, and control data traffic to and from the flowmeter, said communication module being operably coupled to the sensing module and configured to transmit water flow data received from the sensing module, said water flow data being associated with the sensed amount of water flow through the main flow channel.

By isolating and confining the multi-pole magnet to a chamber that is separated from the main flow channel, magnetic attractive forces within the main flow channel are reduced, which, in turn, reduces the potential of ferritic debris (within water flowing through the main flow channel) to migrate towards the multi-pole magnet. The accumulation of debris could otherwise impede the ability of the rotatable member, and thus the multi-pole magnet, to adequately rotate, which would have a negative impact on collection of water flow data in that, if rotation was impacted, then any collected date could be inaccurate and the flowmeter could further become inoperable. One of the drawbacks of some current flowmeter devices is that they suffer from debris accumulation as a result of a rotating magnet member being positioned adjacent to the rotating member (i.e., turbine or paddlewheel or the like), and thus ferritic debris easily accumulates in such devices.

The flowmeter device of the present invention further addresses the issue of debris accumulation in that the rotatable member is shaped and/or sized such that a sufficient clearance is maintained around said rotatable member within the main flow channel to allow debris within water flowing through the main flow channel to pass by the rotatable member. Furthermore, in some embodiments, a flowmeter device of the present invention may include an upper bearing member surrounding an upper portion of the axle member and comprising a void shaped and/or sized to collect fine particles of debris without impeding rotation of the rotatable member and multi-pole magnet. Additionally, or alternatively, a flowmeter device of the present invention may include a lower bearing portion surrounding a lower portion, including a lower end, of the axle member and comprising a void shaped and/or sized to collect fine particles of debris without impeding rotation of the rotatable member and multi-pole magnet.

The present invention is further directed to a system for providing automated water flow monitoring by utilizing one or more of the flowmeter devices within a given property. In particular, the system includes a cloud-based, distributed computing architecture configured to communicate with one or more user-associated computing devices over a network to provide a given user with water flow data from the one or more flowmeter devices. The cloud-based, distributed computing architecture includes, among other things, a server comprising a hardware processor coupled to non-transitory, computer-readable memory containing instructions executable by the processor to cause the server to: 1) receive water flow data from one or more of a plurality of flowmeter devices, wherein each of said flowmeter devices is operably coupled to a respective plumbing fixture of a property and said water flow data comprises a sensed amount of water flow through the each of said flowmeter devices and the respective plumbing fixture; 2) analyze the water flow data to identify water usage information; and 3) report water usage information to a user.

The server may generally be configured to generate billing data based on said analysis of said water flow data and report said billing data to the user and/or identify, based on said analysis of said water flow data, abnormal water usage and report said abnormal water usage to the user. As such, the server may be configured to report an alert of a potential leak to the user based on the abnormal water usage.

The cloud-based, distributed computing architecture generally comprises an on-demand cloud computing platform and service, wherein water flow data is communicated to the server via the on-demand cloud computing platform and service. In particular, based on processing via a rules engine, water flow data may initially be received, decrypted, parsed, and stored in queue via the on-demand cloud computing platform and service for subsequent processing via the server.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram illustrating one embodiment of an exemplary system for providing automated water usage monitoring and management via use of one or more flowmeter devices consistent with the present disclosure.

FIG. 2 is a block diagram illustrating a cloud-based, distributed computing architecture including the water flow monitoring system of FIG. 1 in greater detail.

FIG. 3 is a perspective view of an exemplary embodiment of a flowmeter device consistent with the present disclosure, illustrating an outer enclosure (in phantom) surrounding a majority of the flowmeter device consistent with the present disclosure (with the inlet and outlet remaining exposed to be coupled to a respective water supply line and plumbing fixture).

FIG. 4 is a perspective view of the flowmeter device (with the outer enclosure removed) illustrating various components.

FIG. 5 is a perspective view, partly in section, showing internal components of the flowmeter device in greater detail.

FIG. 6 is a perspective sectional view of the flowmeter device consistent with the present disclosure.

FIG. 7 is a perspective sectional view of a traditional flowmeter device.

FIG. 8A is a sectional view of a traditional flowmeter device illustrating accumulation of debris during water flow due to poor design of the rotating paddlewheel and magnet.

FIG. 8B is a sectional view of a flowmeter device consistent with the present disclosure illustrating reduction of potential for accumulation of debris as a result of the unique design, specifically isolation/confinement of the multi-pole magnet from the main fluid pathway.

FIGS. 9 and 10 are sectional views of other exemplary embodiments of a flowmeter device consistent with the present disclosure, illustrating the inclusion of voids in an upper bearing member and a lower bearing portion respectively surrounding an upper portion and a lower portion of the axle member, wherein such voids are shaped and/or sized to collect fine particles of debris without impeding rotation of the rotatable member and multi-pole magnet.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present invention is directed to the field of water flow monitoring and management. In particular, the invention is directed to a system for use in a property of facility having a plurality of water outlets and/or plumbing fixtures (i.e., residential and/or commercial buildings, including large, multi-unit housing or commercial complexes), wherein the system is configured to monitor and identify water flow and usage.

In particular, the present invention is directed to a uniquely designed flowmeter device configured to be coupled to a plumbing fixture or water outlet (i.e., a faucet, showerhead, toilet, etc.) and provide improved and automated monitoring of water flow characteristics through such plumbing fixture or water outlet, allowing for monitoring of overall water usage, wherein such water usage information is useful in determining and associating appropriate billing of water usage to a corresponding user, as well as identifying abnormal water usage indicative of potential leaks or damage to the plumbing fixture or supply line(s).

A system consistent with the present disclosure may generally include a plurality of flowmeter devices, each designed to be connected to a respective water outlet or plumbing fixture within a housing or a commercial unit and subsequently measure water flow therethrough.

More specifically, the uniquely designed flowmeter device of the present invention includes, among other things, 1) a main flow channel defining a fluid pathway and comprising an upstream inlet and a downstream outlet, the main flow channel configured to receive water flowing from a water supply line and provide said water to a plumbing fixture, 2) a rotatable member positioned within the main flow channel between the inlet and outlet and configured to rotate in response to water flowing through the main flow channel, the rotatable member being mounted to an axle member, and 3) a multi-pole magnet mounted to an upper end of the axle member and isolated from the main flow channel via a bearing plate positioned about the axle member and enclosing the multi-pole magnet and upper end of the axle member within a chamber separated from the main flow channel, the multi-pole magnet configured to correspondingly rotate upon rotation of the rotatable member. The flowmeter device further includes a sensing module configured to sense an amount of water flow through the main flow channel based, at least in part, on rotation of the rotatable member and corresponding rotation of the multi-pole magnet, and a communication module configured to transmit, receive, and control data traffic to and from the flowmeter, said communication module being operably coupled to the sensing module and configured to transmit water flow data received from the sensing module, said water flow data being associated with the sensed amount of water flow through the main flow channel.

The system includes a cloud-based, distributed computing architecture configured to communicate with one or more user-associated computing devices over a network to provide a given user with water flow data from the one or more flowmeter devices. The cloud-based, distributed computing architecture includes, among other things, a server comprising a hardware processor coupled to non-transitory, computer-readable memory containing instructions executable by the processor to cause the server to: 1) receive water flow data from one or more of a plurality of flowmeter devices; 2) analyze the water flow data to identify water usage information; and 3) report water usage information to a user. In particular, the system of the present disclosure can be used to supply data of water usage on a given unit or plumbing fixture basis. Such data could be real-time data (e.g., alerts of leakage, water limits or overall consumption) or billing data. The system is able to process and analyze the data, wherein said analysis could be per individual unit or plumbing fixture or be performed on big-data basis. Such analysis could help design demand and usage planning, or other purposes as known in the art.

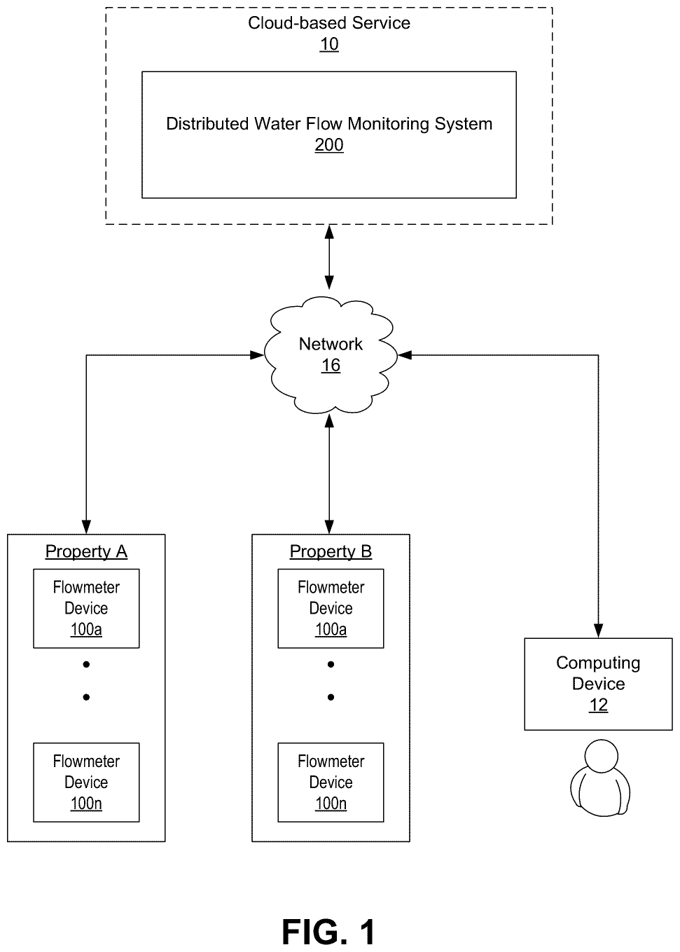

FIG. 1 is a block diagram illustrating one embodiment of an exemplary system for providing automated water usage monitoring and management via use of one or more flowmeter devices consistent with the present disclosure.

As shown, a distributed water flow monitoring system 200 may be embodied on an internet-based computing system/service. For example, as shown, the system 200 may be embodied on a cloud-based service 10, for example. The distributed water flow monitoring system 200 is configured to communicate and share data with at least a computing device 12 associated with a user. The user may include, for example, an individual or group associated with the management and/or ownership of a given property in which the water usage is being monitored. The computing device 12 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. In the embodiments described here, the client device 12 is generally embodied as a computer, a desktop computer, a personal computer (PC), a tablet computer, a laptop computer, a notebook computer, and the like.

The system 200 is further configured to communicate with a plurality of flowmeter devices (100a-100n) in a given property, as described in greater detail herein. The system 200 is configured to communicate and exchange data with the computing device 12 and the plurality of flowmeter devices (100a-100n) over a network 16, for example.

The network 16 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the computing device 14 and the system 100 may be, in whole or in part, a wired connection.

The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G), fifth generation (5G), and future generations of cellular-based data communication technologies, Bluetooth radio, Near Field Communication (NFC), the most recently published versions of IEEE 802.11 transmission protocol standards, other networks capable of carrying data, and combinations thereof. In some embodiments, network 16 is chosen from the internet, at least one wireless network, at least one cellular telephone network, and combinations thereof. As such, the network 16 may include any number of additional devices, such as additional computers, routers, and switches, to facilitate communications. In some embodiments, the network 16 may be or include a single network, and in other embodiments the network 16 may be or include a collection of networks.

The system 200 is configured to communicate and share data with a computing device 12 associated with a user, that may include, for example, one or more persons associated with management over a given property and/or individual units of a given property, such as a landlord, property management, owner, and the like. The data my generally be in the form of water usage information for a specific plumbing fixture within a given unit, and/or all water usage associated with a unit within the given property, and/or water usage associated with the entire property. Such data could be real-time data (e.g., alerts of leakage, water limits or overall consumption) or billing data. The system is able to process and analyze the data, wherein said analysis could be per individual unit or plumbing fixture or be performed on big-data basis. Such analysis could help design demand and usage planning, or other purposes as known in the art.

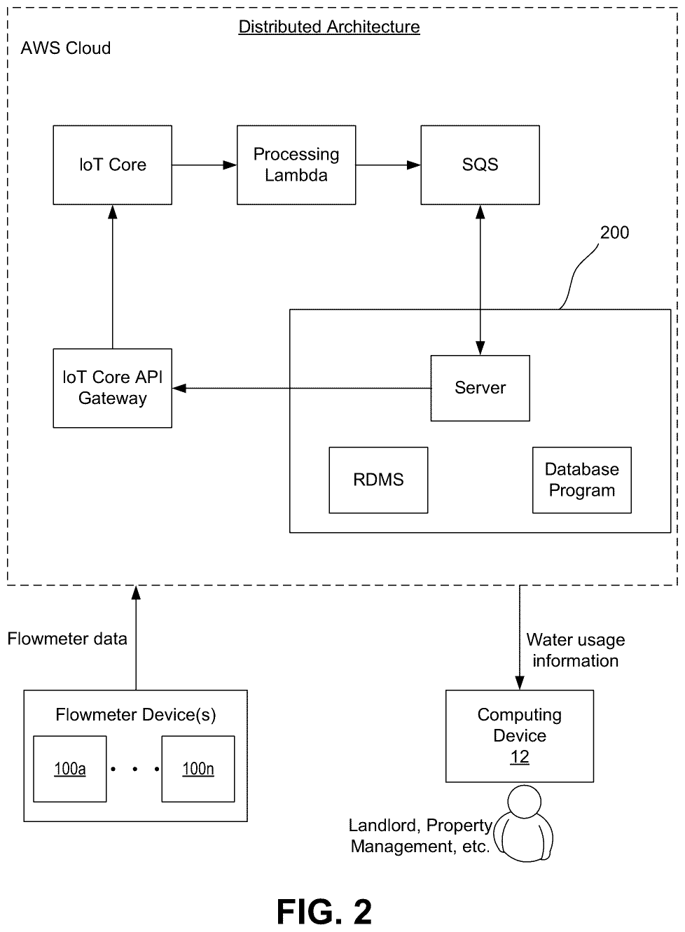

FIG. 2 is a block diagram illustrating a cloud-based, distributed computing architecture including the water flow monitoring system 200 of FIG. 1 in greater detail. As shown, the system 200 may be implemented in a cloud-based, distributed computing architecture configured to communicate with one or more user-associated computing devices over a network and the plurality of flowmeter devices. The distributed water flow monitoring system 200 may generally include a server, a relational database management system (RDMS), such as MySQL®, and a database program, such as MongoDB®. The server may generally receive, in real-time, or near real-time, water flow data from one or more of a plurality of flowmeter devices, wherein each of said flowmeter devices is operably coupled to a respective plumbing fixture of a property and said water flow data comprises a sensed amount of water flow through the each of said flowmeter devices and the respective plumbing fixture. In turn, the server is configured to analyze the water flow data to identify water usage information and subsequently provide a report of water usage information to a given user. For example, the server, based on certain logic, may be configured to generate billing data based on the analysis of said water flow data and report said billing data to the user. The server, based on certain logic, may be configured to identify, based on said analysis of said water flow data, abnormal water usage and report said abnormal water usage to the user, which may include reporting an alert of a potential leak in the plumbing based on the abnormal water usage.

As shown, the cloud-based, distributed computing architecture further comprises an on-demand cloud computing platform and service, such as Amazon Web Services® (AWS®). For example, water flow data may generally be communicated to the server via the on-demand cloud computing platform and service, such that, based on processing via a rules engine, water flow data is initially received, decrypted, parsed, and stored in queue via the on-demand cloud computing platform and service for subsequent processing via the server.

For example, the system may be implemented on AWS IoT Core service as a LoRaWAN broker that enables transferring the data to other AWS services for later processing and storing, asynchronously. IoT Core use is very beneficial in that it enables: 1) a user to connect, manage, and scale fleets easily and reliably without provisioning or managing servers; 2) secure device connections and data with mutual authentication and end-to-end encryption; and 3) a user to filter, transform, and act upon device data on the fly, based on defined business rules. As previously described, using a rules engine, each message received from a flowmeter device is forwarded to a lambda function for decryption and parsing and then stored in a queue for later processing by the business-logic server. The queue solution enables high availability and scalability with high data persistence and prevents the data loss that might otherwise occur in current systematic approaches and enables working with very high loads.

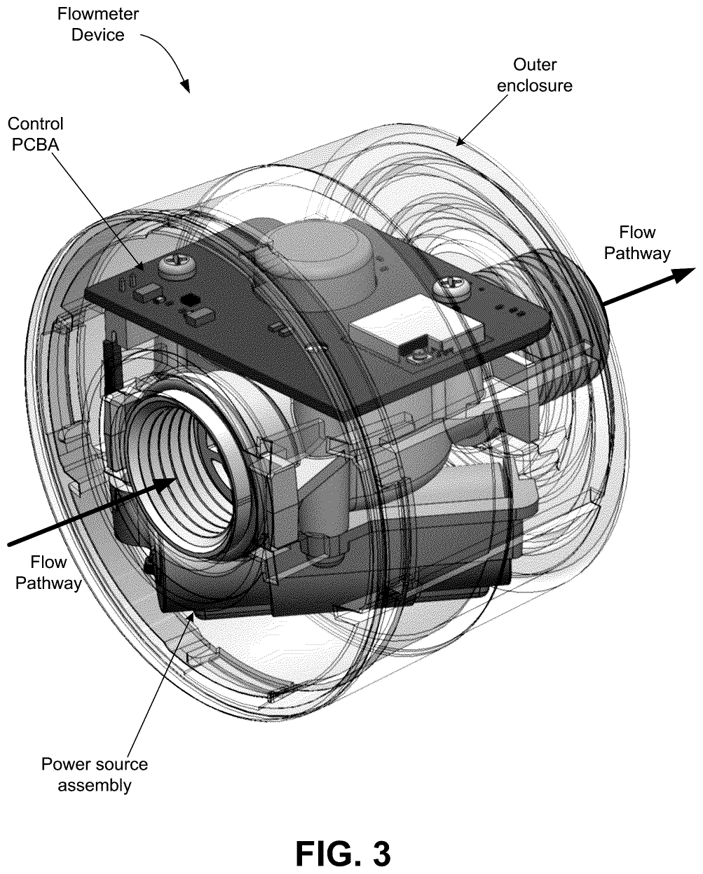

FIG. 3 is a perspective view of an exemplary embodiment of a flowmeter device consistent with the present disclosure. As shown, an outer enclosure (in phantom) generally encloses and surrounds a majority of the flowmeter device, while leaving at least a portion of an inlet and an outlet to be exposed to thereby allow the flowmeter device to be operably coupled to a water supply line(s) and plumbing fixture. The outer enclosure is designed to keep the components safe (i.e., it can provide at least a water-resistant environment, if not a water-tight environment) and allows for easy installment and removal of the flowmeter device by an authorized party. In some embodiments of the present invention, the housing is designed to have a tamper-proof feature. This is due to the main characteristic of the flowmeter device, being low-voltage consuming, and as a result, having a very long battery lifespan. As a result, because there is no need for battery replacement, the outer enclosure could be made in a manner such that the outer enclosure is not removable or has a tamperproof mechanism, such as breakable component, alerting function, or other mechanisms. The outer enclosure may be manufactured by molding or assembling, and may be formed of a polymer, rubber, metal, or other materials in accordance with the specific manner of usage.

It should be noted that O-ring seals or sealants may be provided between the flowmeter device body and enclosure parts to thereby create water-tight seals. The outer enclosure may include interlocking features to thereby create water-resistant seals. For example, there may be corresponding mechanical interlocking features between the outer enclosure and the flowmeter device body to thereby enable tool-less assembly of the flowmeter device to standard plumbing fixtures. The outer enclosure can be held by an installer to provide adequate torque to engage flat sealing gaskets at both ends (at the inlet and outlet).

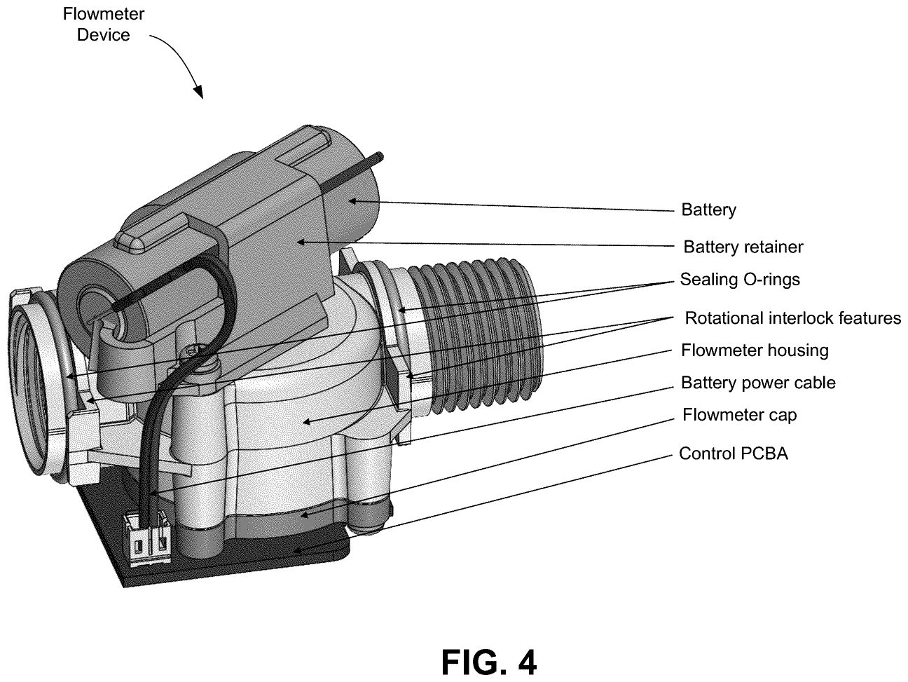

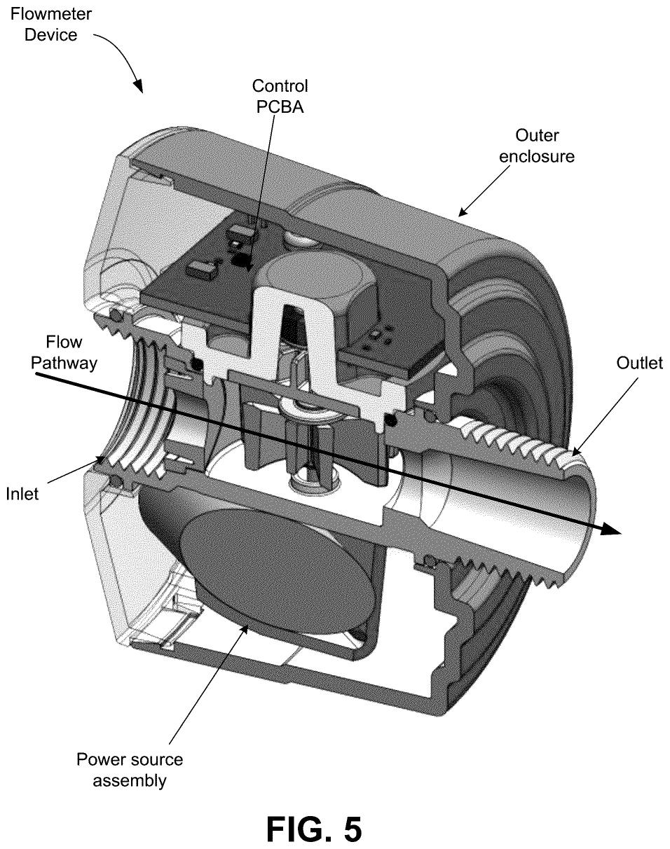

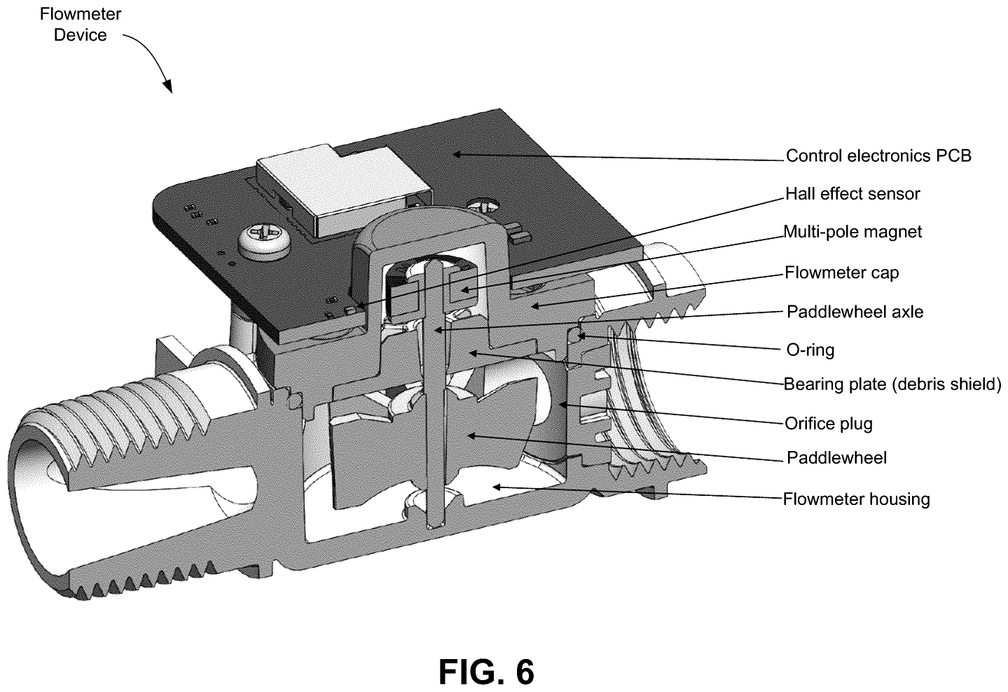

FIG. 4 is a perspective view of the flowmeter device (with the outer enclosure removed) illustrating various components. FIG. 5 is a perspective view, partly in section, showing internal components of the flowmeter device in greater detail. FIG. 6 is a perspective sectional view of the flowmeter device consistent with the present disclosure.

As shown, the flowmeter device includes a main flow channel defining a fluid pathway through which water can flow. For example, the flowmeter includes an upstream inlet and a downstream outlet, wherein the main flow channel is configured to receive water flowing from a water supply line and provide said water to a plumbing fixture. The flowmeter further includes a rotatable member (generally in the form of a paddlewheel, positioned within the main flow channel between the inlet and outlet and configured to rotate in response to water flowing through the main flow channel. The paddlewheel is mounted to an axle member. The flowmeter further includes a multi-pole magnet mounted to an upper end of the axle member. As shown, the multi-pole magnet is isolated from the main flow channel via a bearing plate positioned about the axle member and enclosing the multi-pole magnet and upper end of the axle member within a chamber separated from the main flow channel. Isolation of the multi-pole magnet is highly advantageous, as will be described in greater detail herein. The multi-pole magnet is configured to correspondingly rotate upon rotation of the rotatable member.

The flowmeter device further includes a control printed circuit board assembly (PCBA), which includes various modules. For example, the flowmeter includes a sensing module configured to sense an amount of water flow through the main flow channel based, at least in part, on rotation of the rotatable member and corresponding rotation of the multi-pole magnet. For example, in a preferred embodiment of the present invention, the sensor module includes a Hall effect sensor, which allows for an efficient and manageable low power consumption. It should be noted that any sensor capable of sensing the rotation of the paddlewheel (and thus the multi-pole magnet) member is suitable. As shown, the Hall effect sensor is mounted directly to the PCB, and the sensing module is mounted to a flowmeter cap member enclosing the main flow channel, thereby resulting in a compact form factor.

The flowmeter further includes a communication module configured to transmit, receive, and control data traffic to and from the flowmeter. The communication module is operably coupled to the sensing module and configured to wirelessly transmit water flow data received from the sensing module. The communication module comprises wireless communication components and is designed to exchange data with the distributed water flow monitoring system 200. In preferred embodiments of the present invention, the communication module is a low-power wide-area network (LPWAN), as this type of wireless communication is long-range and low power consuming, thus it may be best suited for the internet of things (IoT) usage. The LPWAN transmission module could be any of the known platforms such as DASH7, WeightLess, LoRa, Sigfox, or others.

The advantage of using an LPWAN module is based on two features: 1) low power consumption allows for long battery life and therefore enables tamper-proof features, both in the structure of the flowmeter device and in the choice of location (e.g., behind walls). Long-range also allows for a broader range of locations and enhances communication of the system throughout the entire complex of units.

As shown in FIG. 4, the flowmeter includes a power unit for providing power to at least one of the sensing module and communication module. The power unit includes a battery (held in place via a battery retainer) and is coupled to the control PCBA via a power cable. The flowmeter device may further include a voltage regulator providing stable voltage for the flowmeter device while battery consumption is kept low.

It should be noted that the control PCBA, including any of the module provided thereon (i.e., the communication module, the sensing module, etc.) generally includes a hardware processor, such as a central processing unit (CPU), and preferably a microprocessor unit, which may include internal or external random access memory (RAM) and optionally a read-only memory (ROM). The memory functions could be used for self-functions and for controlling the entire flowmeter functionality.

As shown, the flowmeter device may further include an orifice insert member positioned within at least one of the inlet and outlet. The orifice insert member can be used to reduce an internal diameter of the main flow channel to thereby control of flow rate range of water flowing through the flowmeter device to thereby maximize accuracy for specific flow rate ranges.

As previously described, the flowmeter device of the present invention is uniquely designed to address certain drawbacks of current water usage monitoring devices. For example, one drawback of water usage monitoring devices is a poor structural design, in that current flowmeter devices are prone to poor accuracy and breaking down due to wear and tear as a result of debris accumulating within internal components thereof.

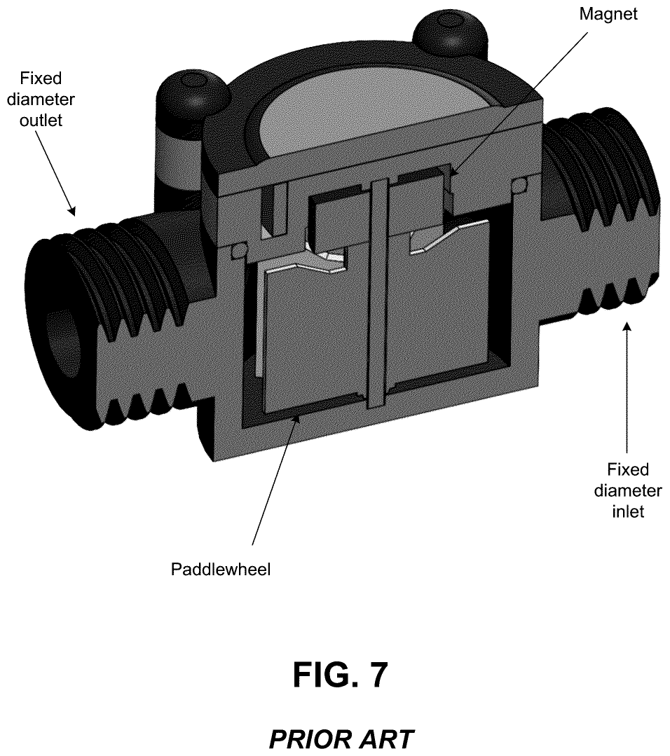

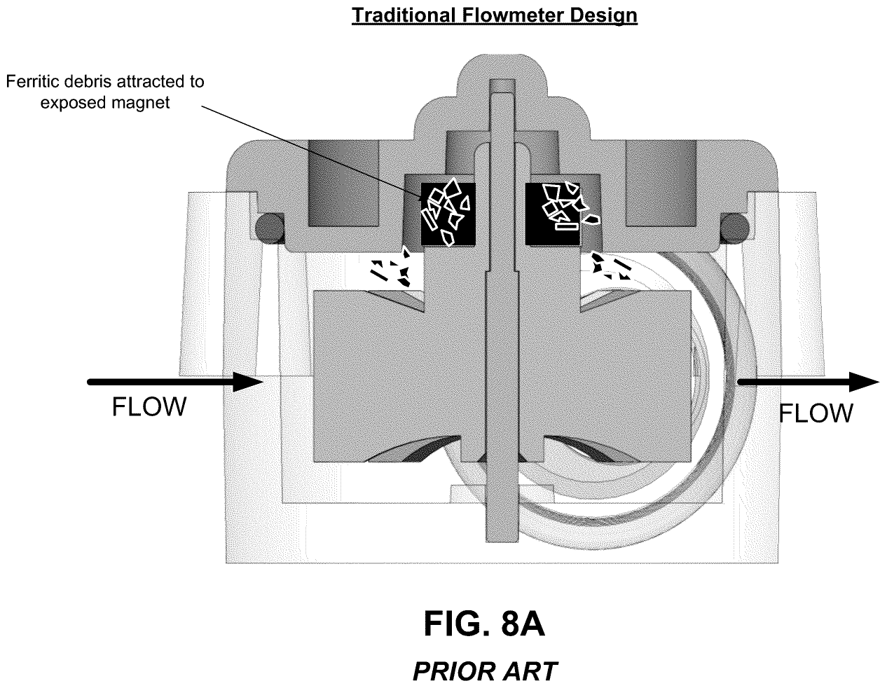

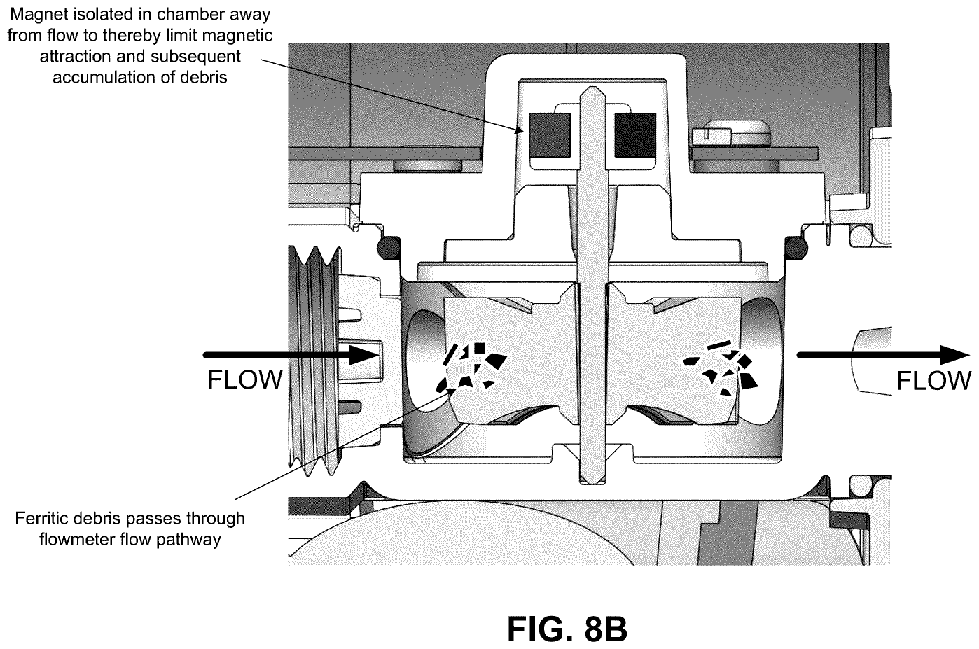

FIG. 7 is a perspective sectional view of a traditional flowmeter device. FIG. 8A is a sectional view of a traditional flowmeter device illustrating accumulation of debris during water flow due to poor design of the rotating paddlewheel and magnet. The traditional flowmeter design includes a multi-pole magnet mounted adjacent to a finned paddlewheel, such that flowing water has direct access to the magnet, thereby allowing magnetic (i.e., ferritic) particles or debris to accumulate on the surface of the magnet due to the attractive magnetic forces. Over time, the particles can build up and degrade the accuracy of meter, or even stall the paddlewheel completely. Furthermore, with a traditional flowmeter device, the Hall Effect magnet sensor is directly wired or placed on a small PCB that is captured between plastic covers and has wire leads for connection to a control board, wherein the use of wire leads can be another potential instance for breakdown. Furthermore, the inlet and outlet of a traditional flowmeter device have a fixed diameter.

The flowmeter device of the present invention has a unique design to address drawbacks of currently offered flowmeter devices. As previously described, in the flowmeter device of the present invention, the rotatable member (i.e., paddlewheel) and the multi-pole magnet are each mounted to separate portions of the axle member. In particular, while the paddlewheel is mounted generally to a central portion of the axle member and positioned within the main flow channel between the inlet and outlet, the multi-pole magnet is mounted to an upper end of the axle member and isolated from the main flow channel via a bearing plate positioned about the axle member and enclosing the multi-pole magnet and upper end of the axle member within a chamber separated from the main flow channel.

FIG. 8B is a sectional view of a flowmeter device consistent with the present disclosure illustrating reduction of potential for accumulation of debris as a result of the unique design, specifically isolation/confinement of the multi-pole magnet from the main fluid pathway. As shown, by isolating and confining the multi-pole magnet to a chamber that is separated from the main flow channel, magnetic attractive forces within the main flow channel are reduced, which, in turn, reduces the potential of ferritic debris (within water flowing through the main flow channel) migrating towards the multi-pole magnet.

The accumulation of debris could otherwise impede the ability of the rotatable member, and thus the multi-pole magnet, to adequately rotate, which would have a negative impact on collection of water flow data in that, if rotation was impacted, then any collected date could be inaccurate and the flowmeter could further become inoperable. One of the drawbacks of some current flowmeter devices is that they suffer from debris accumulation as a result of a rotating magnet member being positioned adjacent to the rotating member (i.e., turbine or paddlewheel or the like), and thus ferritic debris easily accumulates in such devices.

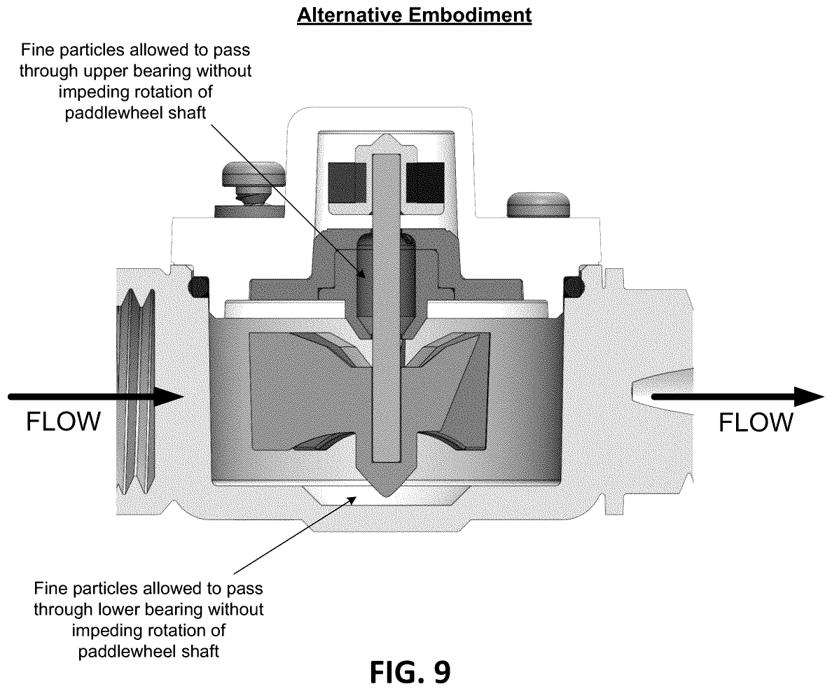

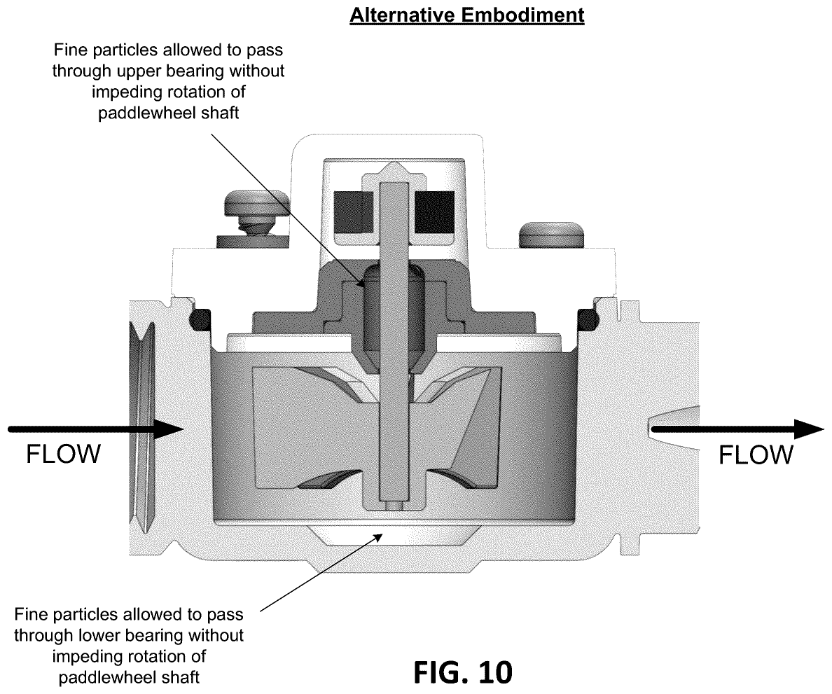

The flowmeter device of the present invention further addresses the issue of debris accumulation in that the rotatable member is shaped and/or sized such that a sufficient clearance is maintained around said rotatable member within the main flow channel to allow debris within water flowing through the main flow channel to pass by the rotatable member. Furthermore, in some embodiments, a flowmeter device of the present invention may include an upper bearing member surrounding an upper portion of the axle member and comprising a void shaped and/or sized to collect fine particles of debris without impeding rotation of the rotatable member and multi-pole magnet. Additionally, or alternatively, a flowmeter device of the present invention may include a lower bearing portion surrounding a lower portion, including a lower end, of the axle member and comprising a void shaped and/or sized to collect fine particles of debris without impeding rotation of the rotatable member and multi-pole magnet. FIGS. 9 and 10 are sectional views of other exemplary embodiments of a flowmeter device consistent with the present disclosure, illustrating the inclusion of voids in an upper bearing member and a lower bearing portion respectively surrounding an upper portion and a lower portion of the axle member, wherein such voids are shaped and/or sized to collect fine particles of debris without impeding rotation of the rotatable member and multi-pole magnet.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A flowmeter device configured to measure of rate of water flowing therethrough, the flowmeter being configured to be operably coupled to a plumbing fixture to thereby provide monitoring of water flow through said plumbing fixture, the flowmeter comprising:
a main flow channel defining a fluid pathway and comprising an upstream inlet and a downstream outlet, the main flow channel configured to receive water flowing from a water supply line and provide said water to a plumbing fixture;
a rotatable member positioned within the main flow channel between the inlet and outlet and configured to rotate in response to water flowing through the main flow channel, the rotatable member being mounted to an axle member;
a multi-pole magnet mounted to an upper end of the axle member and isolated from the main flow channel via a bearing plate positioned about the axle member and enclosing the multi-pole magnet and upper end of the axle member within a chamber separated from the main flow channel, the multi-pole magnet configured to correspondingly rotate upon rotation of the rotatable member;
a sensing module configured to sense an amount of water flow through the main flow channel based, at least in part, on rotation of the rotatable member and corresponding rotation of the multi-pole magnet; and
a communication module configured to transmit, receive, and control data traffic to and from the flowmeter, said communication module being operably coupled to the sensing module and configured to transmit water flow data received from the sensing module, said water flow data being associated with the sensed amount of water flow through the main flow channel.

2. The flowmeter device of claim 1, wherein the rotatable member comprises a paddlewheel.

3. The flowmeter device of claim 1, wherein the rotatable member and the multi-pole magnet are each mounted to separate portions of the axle member.

4. The flowmeter device of claim 1, wherein the bearing plate comprising a lubricious polymer material.

5. The flowmeter device of claim 1, wherein isolation of the multi-pole magnet and confinement to the chamber separated from the main flow channel reduces magnetic attractive forces within the main flow channel thereby reducing potential for the attraction, and resulting migration, of ferritic debris to the multi-pole magnet.

6. The flowmeter device of claim 1, wherein the rotatable member is shaped and/or sized such that a sufficient clearance is maintained around said rotatable member within the main flow channel to allow debris within water flowing through the main flow channel to pass by the rotatable member.

7. The flowmeter device of claim 1, wherein the sensing module comprises a Hall effect sensor for sensing rotation of the multi-pole magnet.

8. The flowmeter device of claim 6, wherein the Hall effect sensor is mounted directly to a control printed circuit board (PCB) of the sensing module and wherein the sensing module is mounted to a flowmeter cap member enclosing the main flow channel, thereby resulting in a compact form factor.

9. The flowmeter device of claim 1, further comprising an upper bearing member surrounding an upper portion of the axle member and comprising a void shaped and/or sized to collect fine particles of debris without impeding rotation of the rotatable member and multi-pole magnet.

10. The flowmeter device of claim 1, further comprising a lower bearing portion surrounding a lower portion, including a lower end, of the axle member and comprising a void shaped and/or sized to collect fine particles of debris without impeding rotation of the rotatable member and multi-pole magnet.

11. The flowmeter device of claim 1, further comprising a power unit for providing power to at least one of the sensing module and communication module.

12. The flowmeter device of claim 11, wherein the power unit comprises a battery and a voltage regulator.

13. The flowmeter device of claim 1, further comprising an orifice insert member positioned within at least one of the inlet and outlet.

14. The flowmeter device of claim 13, wherein the orifice insert member reduces an internal diameter of the main flow channel to thereby control of flow rate range of water flowing through the flowmeter device.

15. The flowmeter device of claim 1, further comprising an outer enclosure surrounding a majority of the flowmeter device and providing at least a water-resistant seal.

16. A system for providing automated water flow monitoring, the system comprising:
a cloud-based, distributed computing architecture configured to communicate with one or more user-associated computing devices over a network, the cloud-based, distributed computing architecture comprising:
a server comprising a hardware processor coupled to non-transitory, computer-readable memory containing instructions executable by the processor to cause the server to:
receive, in real-time, or near real-time, water flow data from one or more of a plurality of flowmeter devices, wherein each of said flowmeter devices is operably coupled to a respective plumbing fixture of a property and said water flow data comprises a sensed amount of water flow through the each of said flowmeter devices and the respective plumbing fixture;
analyze the water flow data to identify water usage information; and
report water usage information to a user.

17. The system of claim 16, wherein the server is configured to generate billing data based on said analysis of said water flow data and report said billing data to the user.

18. The system of claim 16, wherein the server is configured to identify, based on said analysis of said water flow data, abnormal water usage and report said abnormal water usage to the user and report an alert of a potential leak to the user based on the abnormal water usage.

19. The system of claim 16, wherein said cloud-based, distributed computing architecture further comprises an on-demand cloud computing platform and service.

20. The system of claim 19, wherein water flow data is communicated to the server via the on-demand cloud computing platform and service and, based on processing via a rules engine, water flow data is initially received, decrypted, parsed, and stored in queue via the on-demand cloud computing platform and service for subsequent processing via the server.
